(19) United States
(12) Patent Application Publication
(10) Pub. No.: US 2008/0134918 A1
(43) Pub. Date: Jun. 12, 2008

(54) PRINTING PLATE, MANUFACTURING METHOD FOR THE SAME AND LIQUID CRYSTAL DISPLAY DEVICE MADE USING THE SAME

(75) Inventor: Kyounei YASUDA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kanagawa (JP)

(21) Appl. No.: 11/938,391

(22) Filed: Nov. 12, 2007

(30) Foreign Application Priority Data
Dec. 7, 2006 (JP) 2006-330599

(51) Int. Cl. B41N 1/12; B41M 5/00

(52) U.S. Cl. 101/457; 101/465

(57) ABSTRACT

A printing plate for an offset printing is provide. it includes a substrate and a plurality of concave printing plate patterns formed on the substrate. At least one auxiliary pattern is located on a bottom of at least one of the concave printing plate patterns and away from a side face of the concave printing plate pattern. Thereby, even if a plurality of inside void parts occur in a function pattern, an area thereof is small and each inside void part is isolated.

### INCORPORATION BY REFERENCE

This application is based upon and claims the benefit of priority from Japanese Patent Application No. 2006-330599, filed on Dec. 7, 2006, the disclosure of which is incorporated herein in its entirety by reference.

### BACKGROUND OF THE INVENTION

1. Technical Field

The present invention relates to a printing plate, a method for manufacturing the same and a liquid crystal display (LCD) device made using the method, and in particular, relates to the printing plate for a letterpress offset printing, the method for manufacturing the same and the LCD device made using the method.

2. Background Art

In recent years, an LCD device is widely used as a high-resolution display. The LCD device includes functional substrates of which a TFT (thin film transistor) substrate and a CF (color filter) substrate face each other. A Liquid crystal is filled in a gap between the TFT substrate and the CF substrate.

A plural of switching elements such as thin film transistors and electrodes are formed on the TFT substrate, and a color filter, a black matrix and a plurality of electrodes are formed on the CF substrate.

An alignment direction of a liquid crystal molecule changes according to an electric field between the electrodes of the two substrates. The alignment direction of the liquid crystal molecule controls amount of light transmission through the substrates. Thereby, information can be displayed.

The functional substrate includes various patterns with different width and different space thereon. As small space patterns, high definition patterns such as wiring lines and electrodes are exemplified. As comparatively large space patterns, a color filter is exemplified. These patterns are formed using a photolithographic method.

A circuit pattern, an electrode pattern and a contact hole pattern or the like are described as a function pattern, and a substrate in which these functional patterns are formed is described as a functional substrate. In the photolithographic method, processes are complicated and require an expensive production unit. Accordingly, there is a problem that a production cost becomes high.

An alternative technology which lowers the production cost is proposed. For example, an offset printing is proposed in Japanese Patent No. 3730002 as the alternative technology.

FIG. 12 is a diagram illustrating the offset printing. First, a coater 4 in which an ink 5 including a resist material is filled is prepared. A blanket 1 touches the coater 4 and rotates. Thereby, the ink 5 of a uniform thickness is applied on an outer surface 38 of the blanket 1. A silicone resin is formed on the outer surface 38 of the blanket 1.

Next, the blanket 1 on which a coating film of the ink 5 is applied rolls while pressing a printing plate 6. Thereby, the ink 5 is transferred onto the printing plate 6.

A concave printing plate pattern 35 shown in FIG. 12 corresponds to a function pattern. Therefore, the ink 5 which touched the printing plate 6 is transferred onto the printing plate 6. However, because the printing plate pattern 35 is concave, the ink 5 which corresponds to the pattern 35 is not transferred and remains on the blanket 1. In FIG. 12, a part of the ink 5 on the blanket 1 is transferred on the printing plate 6 as an ink 39, and a part of the ink 5 on the blanket 1 remains thereon as an ink pattern 36. The blanket 1 on which the ink pattern 36 is formed rolls while pressing a substrate 8. Thereby, the ink pattern 36 is transferred onto the substrate 8. A transferred ink pattern 7 corresponds to the transferred ink pattern 36 in FIG. 12.

Because the printing plate pattern 35 is formed by a photolithographic method in the printing process, dimensional accuracy of the ink pattern 36 formed on the blanket 1 becomes equal to dimensional accuracy obtained by the photolithographic method. Therefore, dimensional accuracy of a transferred ink pattern 7 becomes equal to the dimensional accuracy of the ink pattern 36 formed on the blanket 1, that is, the dimensional accuracy of the photolithographic method.

However, when a width of the printing plate pattern 35 is wide, a defect so-called an inside void may occur. FIGS. 13A, and 13B and FIGS. 14 A and 14B illustrate cause of generation thereof.

FIGS. 13A and 13B show the printing plate pattern 35 having a narrow width pattern. FIGS. 14A and 14B show the printing plate pattern 35 including a comparatively large width pattern. Here, a width of the printing plate pattern 35 is defined as a width size in a direction where the blanket 1 rolls.

As shown in FIG. 13A, when the width dimension of the printing plate pattern 35 is small, the outer surface 38 of the blanket 1 does not touch a bottom 24 of the printing plate pattern 35, while the blanket 1 rolls on the printing plate pattern 35. Therefore, as shown in FIG. 13B, the ink 5 is not transferred onto the bottom 24.

On the other hand, as shown in FIG. 14A, when the width of the printing plate pattern 35 is wide, the outer surface 38 of the blanket 1 may touch the bottom 24 while the blanket 1 rolls on the printing plate pattern 35. When the outer surface 38 of the blanket 1 touches the bottom 24, as shown in FIG. 14B, the ink 5 is transferred onto the bottom 24.

An inside void generating area 20 corresponds to an area where the outer surface 38 of the blanket 1 touches the bottom 24 of the printing plate pattern 35, shown in FIG. 14A. A remaining ink 21 is the ink 5 transferred onto the bottom 24 in FIG. 14B.

When the ink 21 remains on the bottom 24, a defective part 23 is formed in an ink pattern 36 on the blanket 1. Therefore, when the ink pattern 36 is transferred on the substrate 8, the defective part 23 also occurs in the transferred ink pattern 7.

FIG. 15 shows a top view of a circuit pattern 13 formed by using the ink pattern 7 with the defective part 23 as an etching mask. An inside void part 22 corresponding to the defective part 23 occurs in the circuit pattern 13. A horizontal direction of a space of FIG. 15 corresponds to a vertical direction of a space of FIGS. 14A and 14B.

Boundaries 40 of the inside void part 22 is wavy irregularly. Why the boundaries 40 wave is described below. That is, even if the outer surface 38 of the blanket 1 touches the bottom 24 of the printing plate pattern 35, the outer surface 38 does not touch a surface of the bottom 24 uniformly. As shown in FIGS. 14A and 14B, since the printing plate pattern 35 is formed to be concave portion having a roughly rectangle shape, while passing the printing plate pattern 35, a printing pressure which acts between the blanket 1 and the printing plate 6 is eased. Due to such a relaxing action, the outer surface 38 of the blanket 1 insufficiently touches the bottom 24 of the printing plate pattern 35. Thus, a variation occurs in a degree of transferring even if the outer surface 38 touches the bottom 24, and an exfoliation of the ink 5 corresponding to a touching power is generated when the outer surface 38 is separated from the bottom 24. On these accounts, the boundaries 40 with an irregular shape mentioned above are generated.

The above-mentioned problem occurs since the outer surface 38 of the blanket 1 touches the bottom 24 of the printing plate pattern 35. Therefore, in order to solve the above-mentioned problem, it is considered to deepen the printing plate pattern 35 and prevent the outer surfaces 38 from contacting the bottom 24.

However, in such a method, following inconvenience occurs. The printing plate pattern 35 is formed using an etching technology. Therefore, in order to deepen the printing plate pattern 35, a long etching time becomes necessary. A wet etching method is used for an etching of the printing plate pattern 35. The printing plate pattern 35 is isotropically etched in a wet etching method. Thus, since width of the printing plate pattern 35 is various, an appropriate etching condition for a printing plate pattern 35 is not necessarily appropriate to a different printing plate pattern 35. As a result, over etching may occur. The over etching may decrease dimensional accuracy of the printing plate pattern 35.

### SUMMARY

A main object of the present invention is to provide a printing plate with various widths dimensions which forms an ink pattern without a defective part and which is able to obtain pattern accuracy equal to a photolithographic method, a method for manufacturing the printing plate and an LCD device made by using the printing plate. A printing plate for an offset printing, comprising: a substrate; and a plurality of concave printing plate patterns formed on said substrate, wherein at least one auxiliary pattern is located on a bottom of at least one of said concave printing plate patterns and away from a side face of said concave printing plate pattern.

### BRIEF DESCRIPTION OF THE DRAWINGS

Exemplary features and advantages of the present invention will become apparent from the following detailed description when taken with the accompanying drawings in which:

FIGS. 1A and 1B are cross sectional views showing a structure of a printing plate and a printing operation typically using the same according to a first exemplary embodiment of the present invention;

FIGS. 2A to 2C are step cross sectional views showing a method for manufacturing the printing plate according to the first exemplary embodiment of the present invention;

FIGS. 3A and 3B show an example of a circuit pattern formed by using the printing plate according to the first exemplary embodiment and a second embodiment of the present invention;

FIG. 4 is a diagram showing an effect of the present invention;

FIG. 5 shows a fragmentary sectional view of an LCD device produced using the printing plate of the present invention;

FIGS. 6A and 6B are cross sectional views showing a structure of a printing plate and a printing operation typically using the same according to a second-exemplary embodiment of the present invention;

FIGS. 7A and 7B are cross sectional views showing other structure of the printing plate and the printing operation typically using the same according to the second exemplary embodiment of the present invention;

FIGS. 8A to 8F are step cross sectional views showing a method for manufacturing the printing plate according to the second exemplary embodiment of the present invention;

FIGS. 9A to 9E are step cross sectional views showing other method for manufacturing the printing plate according to the second exemplary embodiment of the present invention;

FIGS. 10A and 10B are cross sectional views showing a structure of a printing plate and a printing operation typically using the same according to a third exemplary embodiment of the present invention;

FIGS. 11A to 11F are step cross sectional views showing a method for manufacturing the printing plate according to the third exemplary embodiment of the present invention;

FIG. 12 is a typical cross sectional view of a related offset printing method;

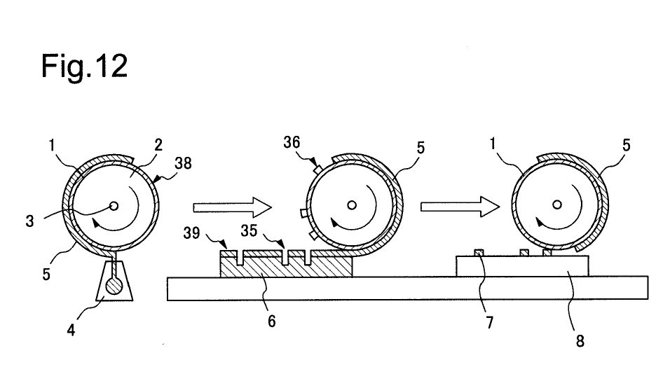

FIGS. 13A and 13B are typical cross sectional views showing a printing operation of a related offset printing when an inside void is not formed;

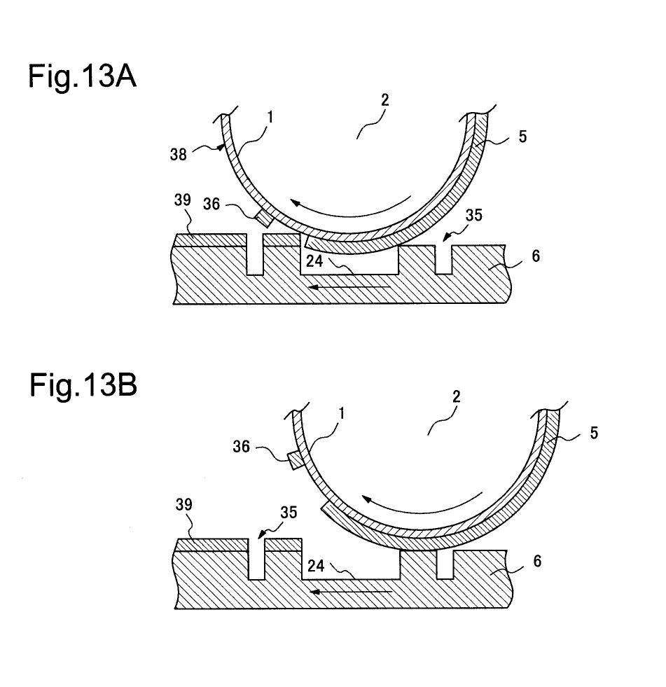

FIGS. 14A and 14B are typical cross sectional views showing a printing operation of a related offset printing when an inside void is formed;

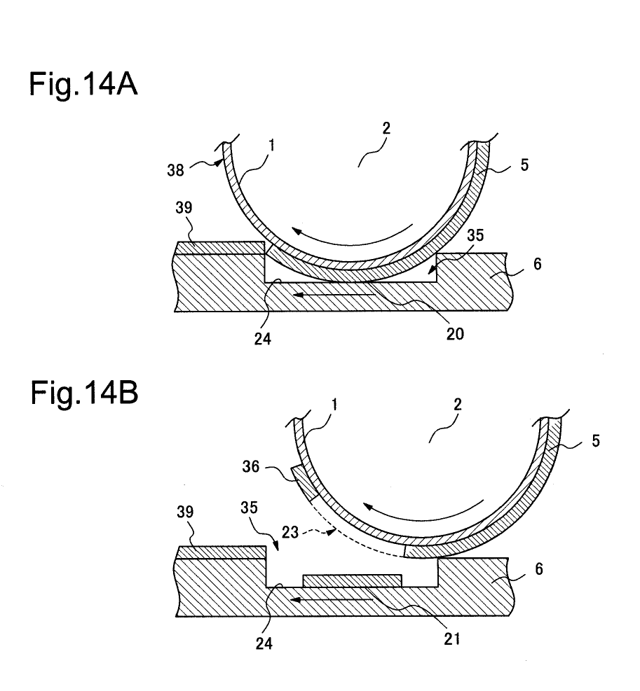

FIG. 15 shows an example of a circuit pattern formed by a related offset printing.

### EXEMPLARY EMBODIMENT

Exemplary embodiments of the present invention will now be described in detail in accordance with the accompanying drawings.

A printing plate for an offset printing includes a concave printing plate pattern, and includes an island-shaped auxiliary pattern which is formed in a concave area of the printing plate pattern. The auxiliary pattern detaches from a side face of the concave area. Thereby, even if a plurality of inside void parts occur in a function pattern, an area thereof is small and each inside void parts are isolated each other. Further, positions of the inside void parts can be regularly arranged.

An ink repellent layer may be provided on the auxiliary pattern so that an ink is not transferred thereon. Thereby, the inside void parts do not occur in the function pattern.

The auxiliary pattern may be formed so as to be lower than a depth of the printing plate pattern. Thereby, when an ink is transferred onto the printing plate, a pressure applied on the auxiliary pattern may be decreased and transferring of an ink thereon is suppressed.

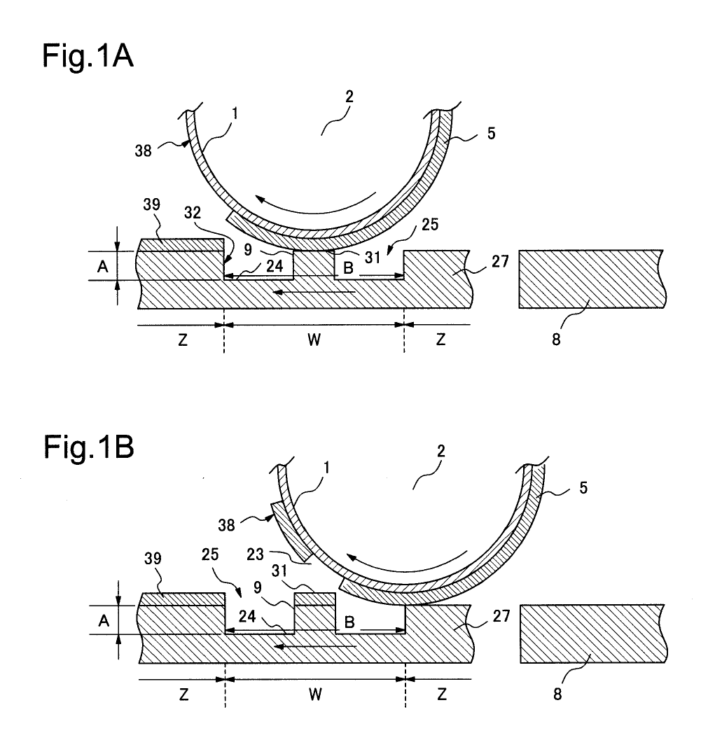

FIGS. 1A and 1B to FIG. 4 are diagrams illustrating a first exemplary embodiment of the present invention. Further, the same symbols denote the same elements in the figures.

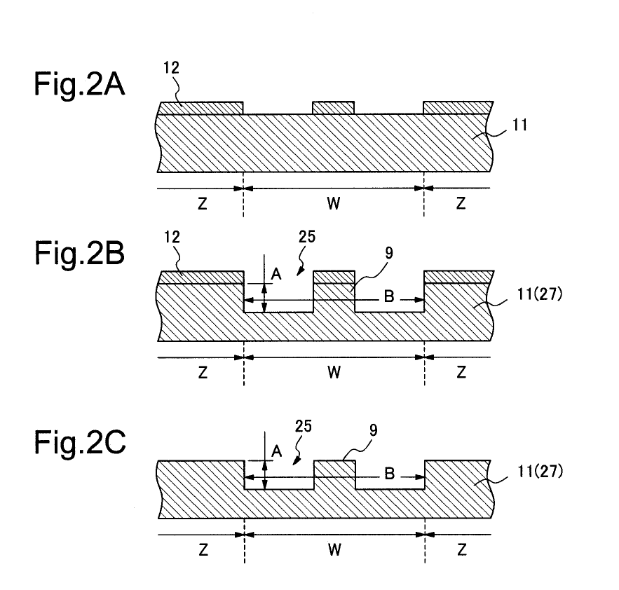

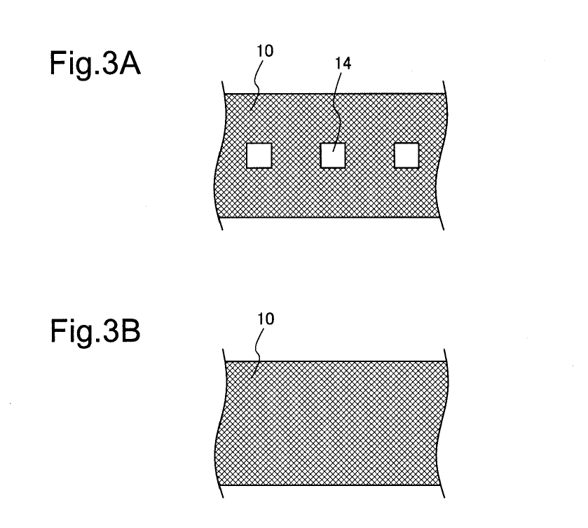

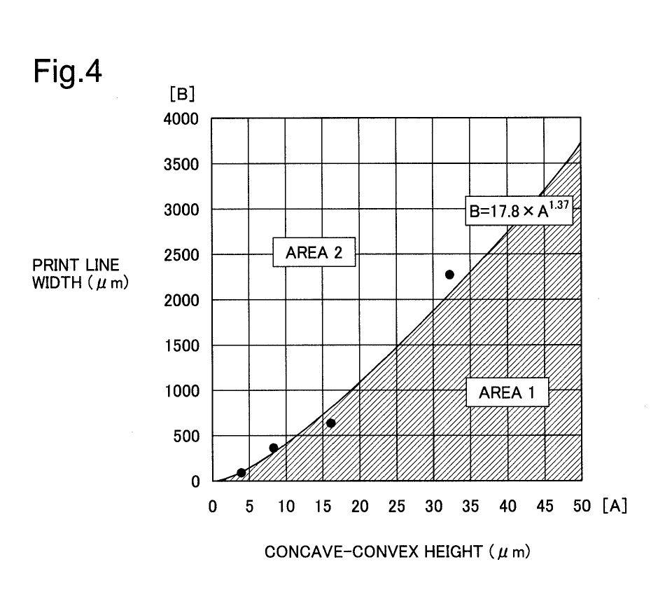

FIGS. 1A and 1B roughly show sections of a printing plate for an offset printing and printing operations. FIGS. 2A to 2C are schematic diagrams roughly showing a manufacturing step for the printing plate. FIGS. 3A and 3B show circuit patterns as final patterns formed using the printing plate. FIG. 4 is a diagram illustrating an effect of the first exemplary embodiment.

First, a structure of the printing plate 27 is described below. As shown in FIGS. 1A and 1B, a printing plate pattern 25 is formed on the printing plate 27 of the first exemplary embodiment. The printing plate pattern 25 is formed by making one or more concave portions in a substrate for a printing plate. The substrate for the printing plate has to be flat and further is made of a material having an excellent ink-philic property, such as a soda lime glass, a non-alkali glass and a silica glass. An auxiliary pattern 9 is formed on a bottom 24 of at least one printing plate pattern 25. The auxiliary pattern 9 detaches from a side face 32 of the printing plate pattern 25. Here, the printing plate pattern 25 is a part corresponding to a function pattern such as a circuit pattern formed on a TFT substrate and a CF substrate. In FIG. 1A to FIG. 11F, an area of the printing plate pattern 25 is indicated by “W”, and an area of a non-printed pattern is indicated by “Z”. When the print line width B of the printing plate pattern 25 exceeds a predetermined size, at least one auxiliary pattern 9 is provided.

FIG. 4 is a diagram showing whether or not an inside void occurs when an ink pattern is printed using a printing plate of a related art. A horizontal axis of FIG. 4 indicates a depth A of the printing plate pattern 25 (i.e. convex height thereof) and a vertical axis of FIG. 4 indicates a width B of the printing plate pattern 25. A curve shown in FIG. 4 satisfies a relation of B=17.8×A 1.37. A hatched area (area 1) under the curve is an area where an inside void is not generated and an area (area 2) over the curve is an area where an inside void is generated.

In the present invention, at least one auxiliary pattern 9 is provided in the printing plate pattern 25 corresponding to the area 2. Thereby, the printing plate pattern 25 corresponding to the area 2 can be regarded as the printing plate pattern 25 corresponding in the area 1, and occurrence of an inside void can be suppressed.

A preferable width of the auxiliary pattern 9 may be around 3 μm to 10 μm. The reason why a minimum width thereof is specified as about 3 μm is described below. That is, a photolithographic method is used for formation of the auxiliary pattern 9, and it is difficult to realize pattern accuracy of no more than 3 μm in the photolithographic method. Further, since there are also various exposure systems such as a contact exposure method and a proximity exposure method in the photolithographic method, dimensional accuracy is different in the respective methods, and a minimum width thereof cannot be specified.

The reason why a maximum width thereof is specified as about 10 μm is described below. That is, a width of a usual wiring line of an LCD device is about 10 μm. Therefore, the width of the printing plate pattern 25 is set to be about 10 μm. For this reason, the upper limit value of the width of the auxiliary pattern 9, which can be formed without touching the side face 32 thereof, will be about 10 μm mentioned above.

Further, because the above-mentioned description premises on present wiring of a present LCD device, when a device with a smaller line width is developed in the future, the upper limit value of the width of the auxiliary pattern 9 may be changed according to the development thereof.

When the present invention is applied to production of a device other than the LCD device, the width of the auxiliary pattern 9 may be limited according to its device.

FIGS. 1A and 1B are the diagrams which exemplified the printing plate 27 of the first exemplary embodiment, and the thickness of the printing plate 27 and the size of the blanket 1 shown in the diagrams do not limit the present invention. The width dimension, the quantity and arrangement or the like of the printing plate pattern 25 and the non-printed pattern Z formed on the printing plate 27 do not limit the present invention.

In FIGS. 1A and 1B, although an impression cylinder 2 is cylindrical, it may be a plane shape other than the cylinder, for example.

A method to perform an offset printing using the printing plate 27 of the first exemplary embodiment is described below. First, as shown in FIG. 1A, the blanket 1 on which an ink 5 is applied uniformly is rolled, while pressing against a substrate 8 shown in FIG. 1A. Thereby, as shown in FIG. 1B, a part of the ink 5 on the blanket 1 is transferred onto a non-printed pattern Z of the printing plate 27.

The blanket 1 is made of a silicone rubber and is provided on an external surface of the impression cylinder 2 which rotates in one direction. A printing plate 27 is made of an ink-philic material or is surface-treated with an ink-philic material. Thereby, the ink 5 on the blanket 1 is transferred onto the non-printed pattern Z certainly. Similarly, the ink 5 on the blanket 1 which touched an auxiliary pattern 9 is transferred onto an upper surface 31 of the auxiliary pattern 9 certainly.

Since an outer surface 38 of the blanket 1 touches the upper surface 31 of the auxiliary pattern 9, the outer surface 38 does not touch the bottom 24. Therefore, a defective part 23 as shown in FIG. 1B is formed in the ink pattern 36 formed on the outer surface 38 of the blanket 1. However, since the defective part 23 corresponds to the upper surface 31 of the auxiliary pattern 9, a formed position, an area and a shape thereof can be controlled. That is, in a printing plate to which the present invention is not applied, there is a problem that a position, an area and a shape of the defective part 23 cannot be controlled. However, in a printing plate to which the present invention is applied, the problems do not occur any more.

After that, the blanket 1 on which the ink pattern 36 is formed is rolled while pressing the substrate 8 as shown in FIG. 1A, and the ink pattern 36 is transferred onto the substrate 8. Thereby, a high-definition resist pattern can be formed on the substrate 8.

In order to transfer the ink 5 onto the substrate 8 certainly, it is desirable to select the substrate 8 with a surface energy larger than that of the blanket 1.

However, when the substrate 8 with the surface energy smaller than that of the blanket 1 is used, it is desirable to enhance an ink-philic property of the surface of the substrate 8.

In order to enhance the ink-philic property, a method to deposit a film such as a hexamethyldisilazane (HMDS) film or the like on the surface of the printing plate 27 can be exemplified.

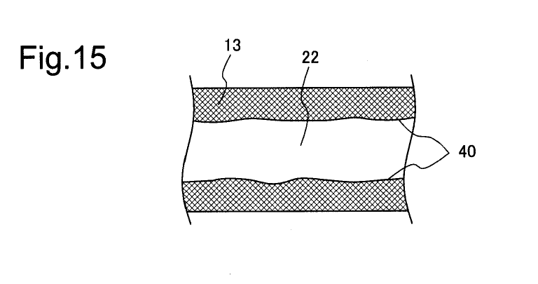

FIG. 3A is an example of a circuit pattern 10 formed using the printing plate 27 as shown in FIG. 1A having the auxiliary patterns 9. As is clear form comparing to the inside void part 22 formed by using the printing plate 6 of the related art shown in FIG. 15, areas of the first exemplary impediment are much smaller and arranged regularly in predetermined positions.

In the printing plate 27 according to the first exemplary embodiment of the present invention, it is not necessary to deepen the printing plate pattern 25 so as to prevent the outer surface 38 of the blanket 1 from touching the bottom 24 thereof. For this reason, without an excess production cost for deepening the printing plate pattern 25, a high-definition pattern can be formed easily.

Thus, according to the printing plate 27 of the first exemplary embodiment of the present invention, a functional substrate such as a TFT substrate having function pattern with high accuracy and various widths can be produced easily.

Next, a method for manufacturing the printing plate 27 will be described with reference to FIGS. 2A to 2C.

First, as shown in FIG. 2A, an etching mask 12 which is a mask for etching a substrate for a printing plate 11 is formed on the substrate 11. The substrate for the printing plate 11 is a base material of the printing plate 27 shown in FIGS. 1A and 1B. The etching mask 12 is made of a metallic film and is formed to cover a shape corresponding to an area of the non-printed pattern Z in FIGS. 1A and 1B. When an auxiliary pattern 9 is needed, the etching mask 12 is also formed on an area corresponding to the auxiliary pattern 9.

The etching mask 12 can be formed using a photolithographic method. For example, a metallic film is formed on the substrate for the printing plate 11, and a resist is applied thereon. And a predetermined pattern is formed by exposing and developing the resist.

Next, after a partial metallic film which is not covered with the resist is etched, the resist is removed.

The metallic film which is made of a material such as chromium (Cr) is formed on the substrate for the printing plate 11 by a vapor deposition method or a sputtering method. The metallic film is etched by a wet etching method.
The above-mentioned resist may be directly used as the etching mask 12. In such a case, the above-mentioned metallic film is unnecessary.

Next, as shown in FIG. 2B, areas of the substrate for the printing plate 11 which is not covered with the etching mask 12 is etched to form concave portions. In the etching method, a wet etching method using a fluoric acid can be employed. An etched depth is set to a concavo-convex height A of the printing plate pattern 25. The concavo-convex height A, for example, may be set to about 2-5 μm. The concavo-convex height A may be adjusted by an etching condition such as an etching time.

Finally, as shown in FIG. 2C, the etching mask 12 is removed by a wet etching, and a printing plate 27 shown in FIGS. 1A and 1B is obtained.

A manufacturing method for producing a TFT substrate using the above-mentioned printing plate 27 will be described below.

Here, a production method of an amorphous silicon (a-Si) TFT substrate 45 with an inversely staggered structure of the channel etched type will be described. However, the method may be also applied to a staggered structure, a poly-silicon TFT or the like.

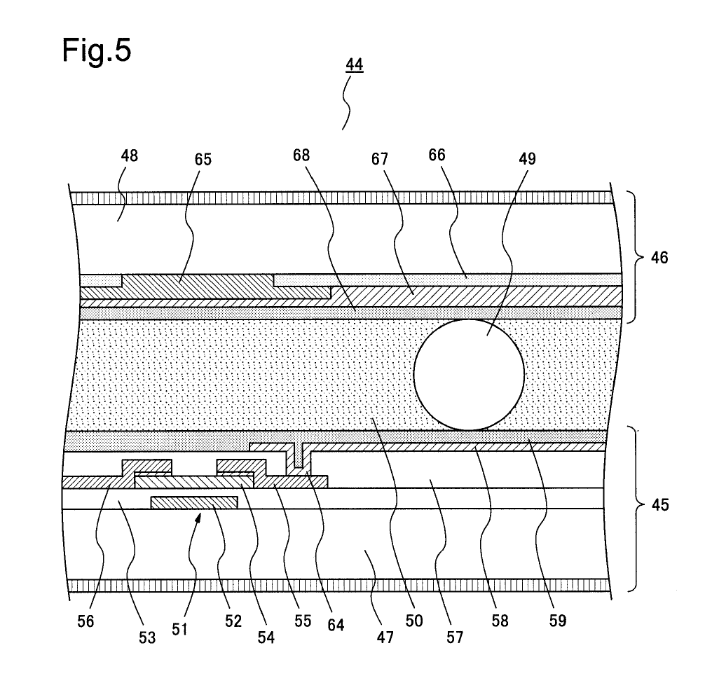

FIG. 5 is a fragmentary sectional view of an LCD device 44 having the TFT substrate 45. The LCD device 44 includes the TFT substrate 45 formed by a transparent insulating substrate 47 and a CF substrate 46 whose base substrate is a transparent insulating substrate 48.

The two substrates 45 and 46 are arranged so as to face each other with a predetermined interval made by a spacer 49, and a liquid crystal 50 is injected therebetween. The TFT substrate 45 includes a plurality of TFTs 51 on the transparent insulating substrate 47 made of a glass or a plastic. The TFT 51 includes a gate electrode 52, a gate insulation film 53 which covers the gate electrode 52, a semiconductor layer 54, a source electrode 55 and a drain electrode 56.

A passivation film 57, a pixel electrode 58 and an alignment layer 59 are formed on the TFT 51. The pixel electrode 58 is connected to an electrode such as a source electrode 55 through a contact hole 64 formed in the passivation film 57.

The CF substrate 46 includes an alignment layer 68, a pixel electrode 67, a black matrix 65, a color filter 66 and a polarizing plate on the transparent insulating substrate 48. An electric field is generated between the pixel electrode 67 and the pixel electrode 58 formed in the TFT substrate 45. The color filter 66 is provided with RGB color layers and makes a color display. The spacer 49 is spherical, for example, and is made of a polymer bead, a silica bead or the like.

The TFT substrate 45 and the CF substrate 46 are manufactured by a similar process basically. An example of manufacturing the TFT substrate 45 using the printing plate 27 will be described below.

First, a gate metallic film is formed, by a sputtering method or the like, on an entire surface of the transparent insulating substrate 47. The gate metallic film is, for example, a laminated film having a molybdenum upper layer of 50 nm in thickness and an aluminum lower layer of 200 nm in thickness can be employed. The lower layer thereof is located in a side of the transparent insulating substrates 47.

Next, a resist pattern for a gate pattern etching is formed using the above-mentioned printing plate 27. The gate metallic film is etched using the resist pattern as an etching mask. The gate metallic film can be etched using a mixed acid which is a mixed-solution of a phosphoric acid, a nitric acid, an acetic acid and water, for example. After an etching of the gate metallic film is completed, the resist is removed. By patterning of this gate metallic film, the gate electrode 52 of the TFT 51 is formed.

When the auxiliary pattern 9 is formed in the printing plate pattern 25, the defective pattern 14 corresponding to the auxiliary pattern 9 occurs in the gate pattern. However, because the defective pattern 14 is isolated and an area thereof in the gate electrode 52 is small sufficiently, a display characteristic is not influenced by the defective pattern 14.

After the gate electrode 52 is formed, a gate insulation film 53 and an a-Si layer and an n+ type a-Si layer are formed in this order. The gate insulation film 53 and the a-Si layer and the n+ type a-Si layer are formed using a plasma CVD method, for example. A thickness of the gate insulation film 53 is set to about 300 nm, and a thickness of the a-Si layer is set to about 200 nm. The a-Si layer becomes a semiconductor layer 54 of the TFT.

Next, a resist pattern for etching the semiconductor layer 54 is formed using the above-mentioned printing plate 27. When the resist pattern is printed on the semiconductor layer 54, it is desirable that an ink-philic property of the surface of the semiconductor layer 54 is improved by a treatment of forming a HMDS film.

These two layers of the n+ type a-Si layer and the a-Si layer are etched using a resist pattern as an etching mask. The resist pattern is removed after the etching. The etching thereof is performed by a dry etching, for example. In such processes, the pattern of the semiconductor region of the two-layered structure is formed. In the area other than the semiconductor region, the gate insulation film 53 is exposed.

The auxiliary pattern 9 is arranged in an area except for a channel region so that the defective pattern 14 does not occur in the channel region. When size of a channel whose region includes the defective pattern 14 changes, transistor characteristics are degraded. In order to prevent the defective pattern 14 from occurring in the channel region, it is preferable to employ a printing plate 27 of following second and third exemplary embodiments.

Next, a drain metallic film is formed all over the transparent insulating substrate 47 using a sputtering method, after the patterning of a semiconductor region is completed. A molybdenum (Mo) film 50 nm thick, a 200 nm thick aluminum (Al) film 200 nm thick and a molybdenum (Mo) film 50 nm thick are formed in turn to form the drain metallic film.

After the drain metallic film is formed, a resist pattern for etching the drain metallic film is formed using the printing plate 27 as shown in FIG. 1A of the first exemplary embodiment. The drain metallic film is etched using the resist pattern as an etching mask. The drain metallic film can be etched using a mixed acid which is a mixed-solution of a phosphoric acid, a nitric acid, an acetic acid and water, for example. By patterning of the drain metallic film, a drain electrode 56 and a source electrode 55 of the transistor are formed simultaneously. The drain electrode 56 and the source electrode 55 are described as a drain layer hereinafter.

The defective pattern 14 corresponding to the auxiliary pattern 9 may be formed in the drain electrode 56 and the source electrode 55 due to the process. However, because the defective pattern is isolated and an area thereof is too small compared with areas of the drain electrode 56 and the source electrode 55 to influence on display characteristics.

Next, an area of the n+ type a-Si layer between the drain electrode 56 and the source electrode 55 in the semiconductor region is etched using a dry etching. After the area of the n+ type a-Si layer between the drain electrode 56 and the source electrode 55 is etched, a resist formed in a process of patterning the drain layer is removed.

After removing the resist, a passivation film 57 such as a SiNx film 200 nm thick is formed all over the transparent insulating substrate 47 using plasma CVD method, for example. Then, a contact hole 64 is formed by etching the passivation film 57 and a gate insulation film 53 thereunder. First, an etching resist pattern is formed on the passivation film 57 using the above-mentioned printing plate 27. The surface of the passivation film 57 may be improved its ink-philic property by forming an HMDS film before the resist pattern is formed.

The passivation film 57 and the gate insulation film 53 are etched using the resist pattern as an etching mask. By the etching to form the contact hole 64, the surfaces of the gate electrode 52 under the gate insulation film 53 and the drain layer are exposed. After the etching to form the contact hole 64 is completed, the resist pattern is removed. A wet etching using chemicals of a buffered hydrofluoric acid can be employed.

The process makes the defective pattern 14 corresponding to the auxiliary pattern 9 besides the contact hole 64. However, because the defective pattern is isolated, an area thereof is quite small compared with a whole pattern and a forming position thereof is controllable, display characteristics are not degraded.

After forming the contact hole 64, a transparent conductive film which becomes the pixel electrode is formed all over the transparent insulating substrate 47 using a sputtering method, for example. The transparent conductive film becomes the pixel electrode 58, and for example, may be made of an indium tin oxide or an indium zinc oxide 50 nm thick.

Next, a resist pattern to form the pattern of the pixel electrode by an etching is printed on the transparent conductive film using the above-mentioned printing plate 27. When the resist pattern is printed, it is desirable to enhance ink-philic property by forming an HMDS film before the resist pattern is printed. The transparent conductive film is etched by a wet etching, for example, using the resist pattern as an etching mask. After etching the transparent conductive film, the resist is removed.

The defective pattern 14 corresponding to the auxiliary pattern 9 may be formed in the pixel electrode pattern. However, because the defective pattern 14 is isolated, an area thereof is quite small compared with a whole pattern and a forming position thereof is controllable, display characteristics are not degraded.

Although the resist pattern for the etching mask is formed using a printing plate 27 of the first exemplary embodiment in the above-mentioned description, the first exemplary embodiment is not limited to such process. A method for printing an ink to form wiring patterns of the TFT substrate and the CF substrate and the pattern of the gate layer directly can be exemplified. In the method, a step of exposing a resist which is used to etch a wiring material and a gate material and a step of removing a resist can be omitted. Thereby, a production cost can decrease.

An example of an ink used for such a method is described below. An ink used for the gate layer, the drain layer and the light shielding layer may include nano-size metal particles. A preferable grain diameter of the metal particle is from 1 nm to 60 nm, more preferably about 5 nm. An ink for the transparent conductive layer used for the pixel electrode may include nano size particles of transparent metallic oxide such as ITO or IZO. An ink for the passivation film may include an acrylic resin dissolved in a solvent. An ink for a color layer of the color filter may include various dyes and pigments dispersed in a solvent. An ink for the semiconductor layer 54 may include pentacene or tetracene dispersed in a solvent. An ink including polythiophene or polyphenylenevinylene which is a conductive polymer can be also exemplified as an ink for the semiconductor layer 54.

As described above, at least one auxiliary pattern 9 is provided inside at least one printing plate pattern 25 in the printing plate 27 of the present invention. Thereby, even when narrow patterns and wide patterns coexist, a dimensional accuracy of the function patterns finally formed is equal to that of a photolithographic method.

When the present invention is applied to production of the TFT substrate and the CF substrate in an LCD device, yield may improve and a production cost may decrease.

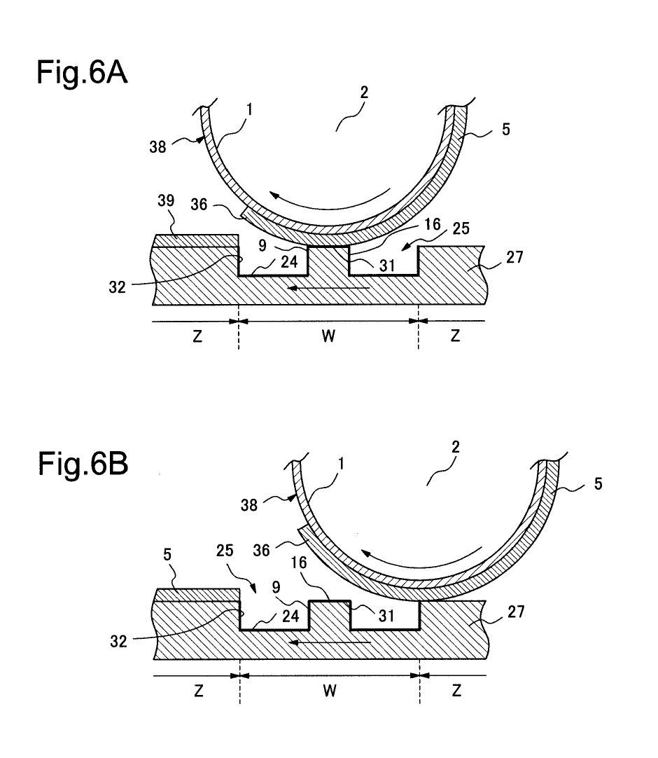

Next, a printing plate for an offset printing of a second exemplary embodiment of the present invention, a manufacturing method and an LCD device will be described with reference to FIG. 6A to 9E.

In the same configuration as the configuration in the first exemplary embodiment mentioned above, the same signs are used, and descriptions of the configuration are omitted appropriately.

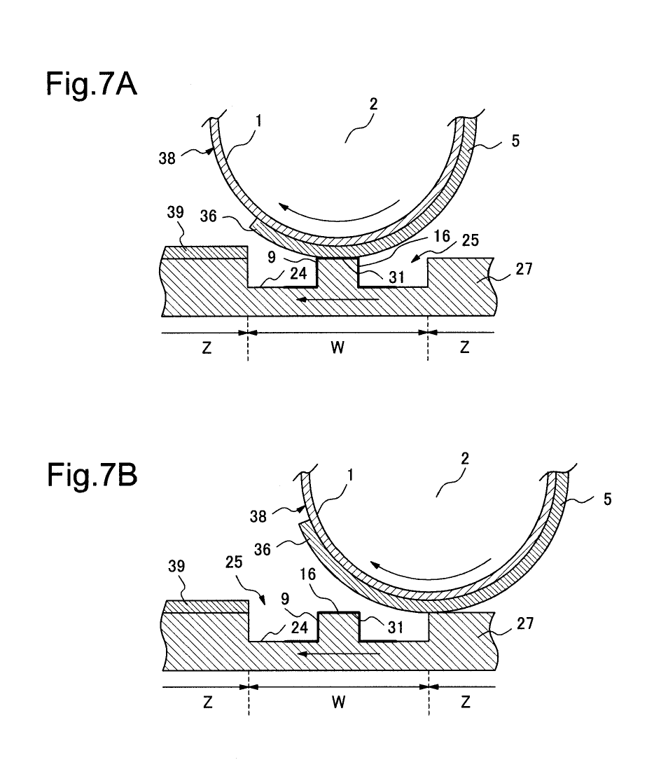

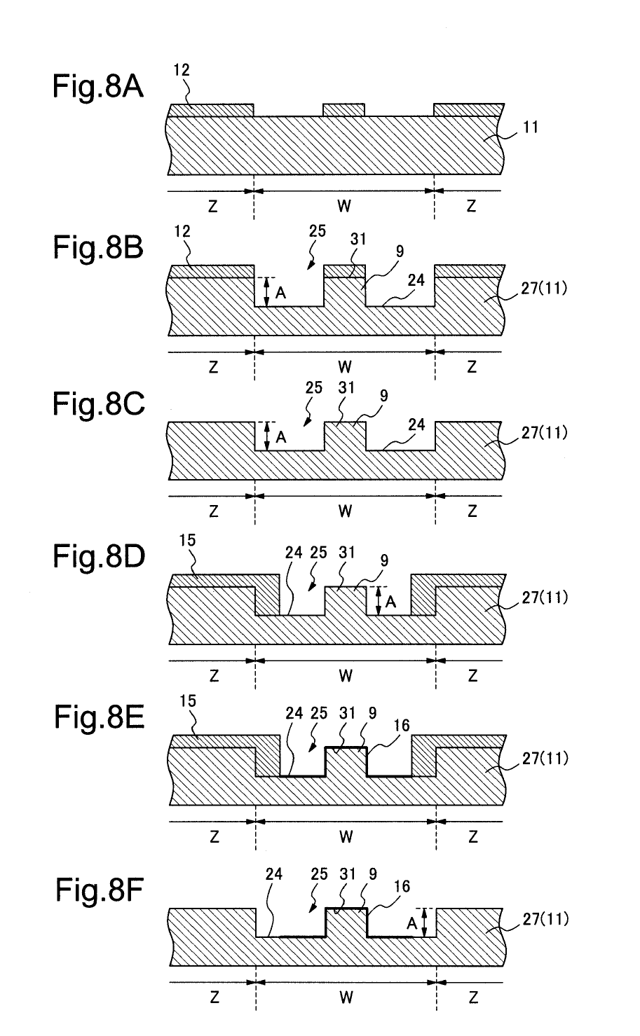

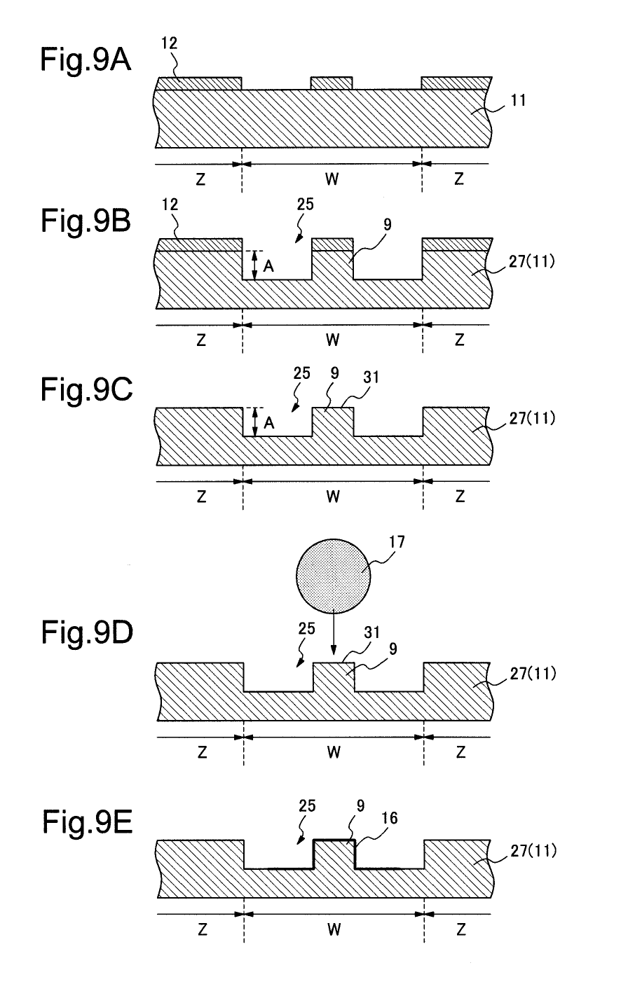

FIGS. 6A, 6B, 7A and 7B are cross sectional views showing structures of the printing plates for an offset printing and printing operations using the same, typically. FIGS. 8A to 8F and FIGS. 9A to 9E are cross sectional views showing a method for manufacturing this printing plate.

The printing plate and the printing operation of the second exemplary embodiment will be described with reference to FIGS. 6A and 6B. First, a structure of the printing plate is described below. The printing plate 27 of the second exemplary embodiment is used for an offset printing. A printing plate pattern 25 is formed to be concave. The printing plate pattern 25 is an area corresponding to a function pattern, and an area which does not correspond to the above-mentioned function pattern is described as a non-printed pattern Z.

At least one auxiliary pattern 9 is formed on a bottom 24 of at least one printing plate pattern 25. The auxiliary pattern 9 is formed so as not to touch a side face 32 of the pattern 25. An ink repellent layer 16 is formed on side faces and bottom faces of the printing plate pattern 25. The ink repellent layer 16 has to be formed on an at least upper surface 31 of the auxiliary pattern 9.

An arrangement and the size of the auxiliary pattern 9, a shape of a impression cylinder 2 and a material of the printing plate 27 are same as that of the first exemplary embodiment.

Next, a printing method using the printing plate of the second exemplary embodiment will be described. First, as shown in FIG. 6A, an ink 5 made of a resist is uniformly applied on an outer circumference surface 38 of a blanket 1 made of a silicone rubber.

The blanket 1 rolls while pressing the printing plate 27, and as shown in FIG. 6B, the ink 5 is transferred onto a non-printed pattern Z. When a material of the printing plate 27 is made of an ink-philic material or a surface thereof is treated with an ink-philic material, the ink 5 is transferred onto the non-printed pattern Z certainly. Then, the blanket 1 also rolls on the auxiliary pattern 9. However, because the ink repellent layer 16 is formed on side faces and bottom faces of the printing plate pattern 25 including the auxiliary pattern 9, the ink 5 is not transferred onto an upper surface 31 of the auxiliary pattern 9. Therefore, a defect of an inside void which is a main subject to be solved in the present invention does not occur any more.

Then, the blanket 1 having an outer surface 38 on which an ink pattern 36 corresponding to a function pattern is formed is pressed on a substrate 8 and rolls. Thereby, the ink pattern 36 is transferred onto the substrate 8. Selection and a treatment of the substrate 8 of the second exemplary embodiment is the same as that of the first exemplary embodiment.

The ink pattern 36 can be transferred on the substrate 8 so as to keep accuracy which is equal to that of a photolithographic method.

Because a defective part 23 does not occur in the ink pattern 36 even if the printing plate 27 with the auxiliary pattern 9 is used, the defective pattern 14 as shown in FIG. 3B does not occur in the function pattern such as a circuit pattern in the second exemplary embodiment.

Therefore, it is not necessary to deepen the printing plate pattern 25 in order to prevent occurrence of the defective part 23 in the printing plate 27. In other words, because the a cost for adjusting a depth of the printing plate pattern 25 on a substrate having narrow patterns and wide patterns becomes unnecessary in the second exemplary embodiment, a production cost thereof can be lowered.

The ink repellent layer 16 mentioned above is formed all over the printing plate pattern 25 in which the auxiliary pattern 9 is provided. However, in the present invention, a forming method of the ink repellent layer 16 is not limited to such configuration.

An essential operation of the ink repellent layer 16 is to prevent the ink 5 applied on the outer surface 38 of the blanket 1 from being transferred on a side face or a bottom of the printing plate pattern 25 including the upper surface 31 of the auxiliary pattern 9. Therefore, the ink repellent layer 16 may be formed as shown in FIGS. 7A and 7B, for example. In the example as shown in FIGS. 7A and 7B, the ink repellent layer 16 is formed on the upper surface 31 and surrounding areas of the auxiliary pattern 9. An area where the ink repellent layer 16 is formed is the side face and the bottom of the printing plate pattern 25 including the upper surface 31 of the auxiliary pattern 9 where the outer circumference surface 38 of the blanket 1 may touch.

Next, a method for manufacturing the printing plate of the second exemplary embodiment will be described. FIGS. 8A to 8F are schematic diagrams of the method for manufacturing the printing plate 27. First, as shown in FIG. 8A, an area which becomes the non-printed pattern Z on the substrate for the printing plate 11 is covered with an etching mask 12 made of a metallic film. When the auxiliary pattern 9 is formed, the etching mask 12 is also formed on an area corresponding to the auxiliary pattern 9.

This etching mask 12 can be made of a chromium film, using a photolithographic method of the first exemplary embodiment. The etching mask 12 may be a resist patterned by a photolithographic method. After forming the etching mask 12, as shown in FIG. 8B, the substrate for the printing plate 11 is etched using the etching mask 12. An etched area becomes a concave printing plate pattern 25. A wet etching method using a fluoric acid may be employed. Etching depth here corresponds to a concavo-convex height A of the printing plate pattern 25. The concavo-convex height A can be formed a height of about 2 μm to 5 μm.

Next, as shown in FIG. 8C, the etching mask 12 is removed by a wet etching. After the etching mask 12 is removed, a mask 15 for an ink repellent processing is formed. The mask 15 for the ink repellent processing is formed by patterning a resist using a photolithographic method.

The mask 15 for the ink repellent processing is formed so that the non-printed pattern Z of the substrate for the printing plate 11 may be covered thereby. FIG. 8D shows an example of a configuration of the mask 15.

Next, as shown in FIG. 8E, an ink repellent layer 16 is formed. The ink repellent layer 16 is formed on an area which is not covered with the mask 15 for the ink repellent processing. Thereby, a part of a bottom of the printing plate pattern 25 and a surface area of the auxiliary pattern 9 becomes ink repellent.

A fluoride coating resin including as polytetrafluoroethylene, a silicone resin such as dimethylsiloxane or the like may be used as a material of the ink repellent layer 16. As a material of the ink repellent layer 16, solution including a silane coupling agent therein may be also employed. When the solution in which the silane coupling agent is dissolved is used, the solution is applied on a surface of the substrate for the printing plate 11, and then the substrate is dried.

As a method of an application, various methods such as a spin coat method, a slit coat method and a spraying method may be used. At that time, it is desirable to use an ink repellent material whose surface energy after drying is smaller than that of the ink 5. Moreover, it is desirable that the surface energy of the ink repellent material is about 18 dyne/cm or less.

As the ink repellent material, when NovecEGC-1720 (made by Sumitomo 3M Corporation) is used, for example, the printing plate pattern 25 after coating includes a surface energy of 13 dyne/cm, and the printing plate pattern 25 shows an excellent function.

Finally, as shown in FIG. 8F, the mask 15 for the ink repellent processing is removed, and the printing plate 27 of the second exemplary embodiment is completed.

FIGS. 9A to 9C are schematic diagrams showing other method for manufacturing a printing plate 27. The steps for forming the printing plate pattern 25 having the auxiliary patterns 9 shown in FIGS. 9A to 9C are similar to the above-mentioned steps shown in FIGS. 8A to 8C.

After the printing plate pattern 25 having the auxiliary patterns 9 is formed, as shown in FIG. 9D, a droplet 17 of an ink repellent material is dropped all over the printing plate pattern 25, an upper surface of the auxiliary pattern 9 or an area including the auxiliary pattern 9. Then, the droplet 17 is dried.

As shown in FIG. 9E, an ink repellent layer 16 is formed on the upper surface 31 of the auxiliary pattern 9 and surrounding areas thereof and the printing plate 27 of the second exemplary embodiment is completed.

At least one island-shaped auxiliary pattern 9 is formed on at least one printing plate pattern 25 and the ink repellent layer 16 is formed at least on the upper surface 31 of the auxiliary pattern 9.

Thereby, even when narrow patterns and wide patterns coexist, a dimensional accuracy of circuit patterns finally formed is equal to that in a photolithographic method.

When a method for forming the printing plate 27 of the second exemplary embodiment is used for production of a TFT substrate and a CF substrate in an LCD device, for example, yield improves and production costs are reduced.

Next, a third exemplary embodiment of the present invention will be described.

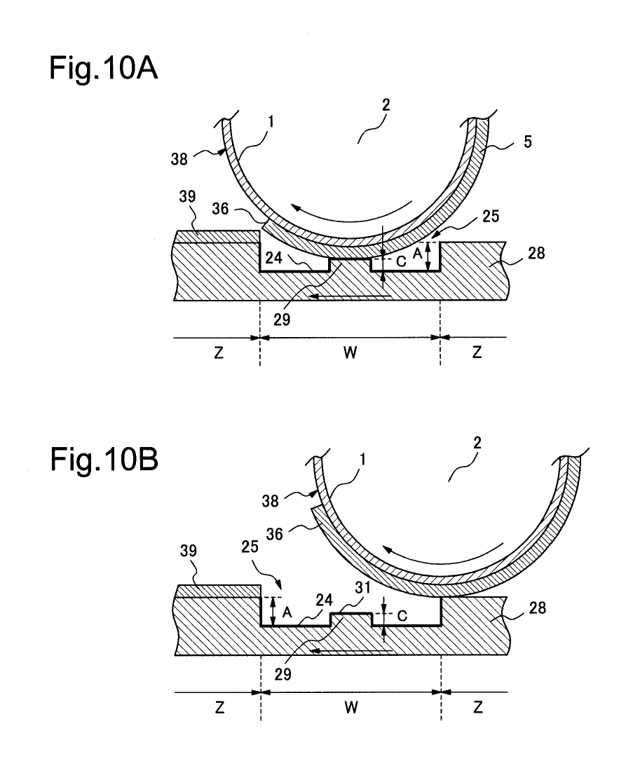

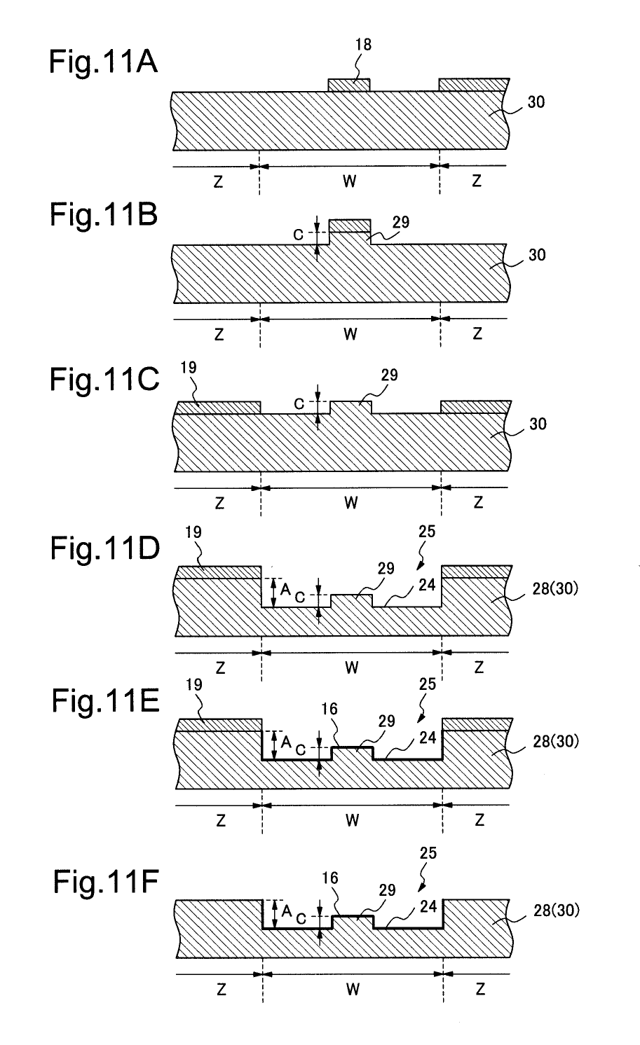

FIGS. 10A, 10B and 11A to 11F illustrate a printing plate for an offset printing of the third exemplary embodiment, a manufacturing method for the printing plate and an LCD device manufactured using the printing plate. FIGS. 10A and 10B are cross sectional views showing a structure of the printing plate for the offset printing of the third exemplary embodiment and the printing operation thereof. FIGS. 11A to 11F are cross sectional views showing a method for manufacturing the printing plate.

The structure of the printing plate of the third exemplary embodiment and the printing operation using the same will be described with reference to FIGS. 10A and 10B.

First, a structure of the printing plate is described. A printing plate 28 of the third exemplary exemplary embodiment can be used for an offset printing, and a printing plate pattern 25 is formed to be concave. An auxiliary pattern 29 is provided in a bottom 24 of at least one printing plate pattern 25. The auxiliary pattern 29 is formed to be a concavo-convex height C lower than a concavo-convex height A of a printing plate pattern 25.

An arrangement and a size of the auxiliary pattern 29, a shape of the impression cylinder 2 and a material of the printing plate 28 are the same these of the first above-mentioned exemplary embodiment. An ink repellent layer 16 may also be formed on an upper surface of the auxiliary pattern 29 in the third exemplary embodiment. Further, a concavo-convex height C of an auxiliary pattern 29 may be zero. In such a configuration, even if an auxiliary pattern 29 is not formed, occurrence of a defective part can be prevented.

Next, a printing method using the printing plate of the third exemplary embodiment will be described. First, as shown in FIG. 10A, an ink 5 such as a resist for an etching mask is uniformly applied on an outer surface 38 of a blanket 1 made of a silicone rubber. The blanket 1 is rolled while pressing on the printing plate 28. The ink 5 is transferred onto a non-printed pattern Z as shown in FIG. 10B. Because an ink-philic material is used as the material of the printing plate 28, the ink 5 is transferred onto the non-printed pattern Z certainly. Therefore, the ink pattern 36 is formed on the outer circumference surface 38 of the blanket 1.

When this ink 5 is transferred, the outer surface 38 of the blanket 1 also touches an upper surface 31 of the auxiliary pattern 29. However, because the concavo-convex height C of the auxiliary pattern 29 is lower than the concavo-convex height A of the printing plate pattern 25, a contact pressure between the outer surface 38 and the auxiliary pattern 29 of the blanket 1 becomes smaller than that between the outer surface 38 and the non-printed pattern Z of the blanket 1. Therefore, it becomes difficult for the ink 5 to be transferred onto the auxiliary pattern 29.

Then, the blanket 1 on whose outer surface 38 only the ink 5 with a desired pattern is formed is rolled on the substrate 8 as shown in FIG. 1A. Thereby, the ink 5 is transferred onto the substrate 8. Selection and treatment of the substrate 8 are is the same as that of the first exemplary embodiment. Thus, a narrow pattern is formed on the substrate 8 by printing the ink 5 thereon.

Next, a method of manufacturing the printing plate of the third exemplary embodiment will be described.

FIGS. 11A to 11F are schematic diagrams of the method of manufacturing the printing plate shown in FIGS. 10A and 10B. First, as shown in FIG. 11A, an area of a substrate for a printing plate 30 in which an auxiliary pattern 29 is to be formed is covered by a first etching mask 18.

This first etching mask 18 can be made of a metallic film of Cr, for example, using a photolithographic method described in the first exemplary embodiment. A resist patterned by a photolithographic method without using a metallic film, may be used as the first etching mask 18.

Next, as shown in FIG. 11B, the substrate for the printing plate 30 is etched. By the etching, an area which is not covered with the first etching mask 18 of the substrate for the printing plate 30 is etched. A etching depth is a concavo-convex height C of an auxiliary pattern 29, and the etching depth may be set to be a depth of about 1-3 μm. Next, the first etching mask 18 is removed by a wet etching. Then as shown in FIG. 1C, a second etching mask 19 corresponding to a non-printed pattern Z is formed.

The second etching mask 19 can be made of a metallic film of Cr, for example, using a photolithographic method like the first exemplary embodiment. A resist patterned by a photolithographic method without using a metallic film, may be used as the second etching mask 19.

Next, as shown in FIG. 11D, the substrate for the printing plate 30 is etched using the second etching mask 19. An etched area becomes a printing plate pattern 25. An etching depth here becomes a concavo-convex height A of the printing plate pattern 25. For example, a size of the concavo-convex height A may be set to 2-5 μm.

When the substrate for the printing plate 30 is etched using the second etching mask 19 as an etching mask, the printing plate pattern 25 including the auxiliary pattern 29 is etched uniformly.

That is, without changing the concavo-convex height C of the auxiliary pattern 29, the substrate for the printing plate 30 is etched. Therefore, when an etching amount of the substrate for the printing plate 30 is adjusted, the concavo-convex height C of the auxiliary pattern 29 can be made to be lower than the concavo-convex height A of the printing plate pattern 25 (C<A).

Next, as shown in FIG. 11E, an ink repellent treatment is performed on a surface of the printing plate pattern 25 which is not covered with the second etching mask 19. Thereby, the surface of the printing plate pattern 25 is covered with an ink repellent layer 16. In order to perform the ink repellent treatment, the same technique and material as the second exemplary embodiment may be employed.

Finally, as shown in FIG. 11F, the second etching mask 19 is removed by a wet etching. Thereby, a printing plate 28 of the third embodiment is completed.

As described above, at least one island-shaped auxiliary pattern 29 having a convex shape is provided on a bottom 24 of at least one printing plate pattern 25. The concavo-convex height C of the auxiliary pattern 29 is formed so as to become lower than the concavo-convex height A of the printing plate pattern 25. Moreover, an ink repellent layer 16 may be formed onto an upper surface of an auxiliary pattern 29, if needed.

Thereby, even when the narrow patterns and wide patterns of function patterns coexist, a dimensional accuracy of the function patterns finally formed becomes equal to a precision of the photolithographic method. When the printing plate 28 of the third exemplary embodiment is used for production of a TFT substrate and a CF substrate in an LCD device, for example, yield improves and production costs are reduced.

Each above-mentioned exemplary embodiment is explained about the case when the substrate 8 of which the LCD device of the TFT substrate and the CF substrate is composed is produced using the printing plate of the present invention. However, the present invention is not limited to the above-mentioned embodiment, and may be applicable to an optional substrate having function patterns in which a narrow pattern and a wide pattern coexist.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A printing plate for an offset printing, comprising:
a substrate; and
a plurality of concave printing plate patterns formed on said substrate, wherein
at least one auxiliary pattern is located on a bottom of at least one of said concave printing plate patterns and away from a side face of said concave printing plate pattern.

2. The printing plate according to claim 1, wherein
a height of said auxiliary pattern is lower than a depth of said printing plate pattern.

3. The printing plate according to claim 2, wherein
an ink repellent layer is formed at least on an upper surface of said auxiliary pattern.

4. The printing plate according to claim 3, wherein
said ink repellent layer includes any one of a fluoride coating resin, a silicone resin and a silane coupling agent.

5. The printing plate according to claim 1, wherein
said auxiliary pattern is provided in said printing plate satisfying B≧17.8×A1.37 (μm), where A (μm) is a depth of said printing plate pattern and B (μm) is a width of said printing plate pattern.

6. The printing plate according to claim 1, wherein
a width of said auxiliary pattern is substantially 3 μm to 10 μm.

7. A method for manufacturing a printing plate for an offset printing having a concave printing plate pattern, comprising:
forming, on a substrate, a resist pattern corresponding to said printing plate pattern and an auxiliary pattern formed in said printing plate pattern so as not to touch a side face of said printing plate pattern; and
forming said printing plate pattern and said auxiliary pattern simultaneously by etching said substrate using said resist pattern.

8. The method for manufacturing a printing plate for an offset printing according to claim 7,
wherein said step of forming said resist pattern comprising:
forming a metallic film on said substrate, and forming said resist pattern on said metallic film; and
wherein said step of forming said printing pattern and said auxiliary pattern comprising:
etching said metallic film using said resist pattern as an etching mask for producing a metallic film resist pattern, and etching said substrate using said metallic film resist pattern as an etching mask.

9. The method for manufacturing a printing plate for an offset printing according to claim 7, wherein
said resist pattern is made of a photoresist pattern and said substrate is etched using said photoresist pattern directly as an etching mask.

10. A method for manufacturing a printing plate for an offset printing having a concave printing plate pattern, comprising:
forming a first etching mask corresponding to an auxiliary pattern;
forming said auxiliary pattern on a substrate of said printing plates by etching using said first etching mask;
forming a second etching mask corresponding to said printing plate pattern; and
forming said printing plate pattern simultaneously with said auxiliary pattern on said substrate by etching using said second etching mask.

11. The method for manufacturing a printing plate for an offset printing according to claim 10, wherein
said first etching mask and said second etching mask include a photoresist.

12. The method for manufacturing a printing plate for an offset printing according to claim 10, wherein
said first etching mask and said second etching mask include a metallic film.

13. The method for manufacturing a printing plate for an offset printing according to claim 10, further comprising:
forming an ink repellent layer on a surface of said printing plate pattern and removing said second etching mask.

14. The method for manufacturing a printing plate for an offset printing according to claim 10, further comprising:
forming an ink repellent layer by dropping a droplet including an ink repellent material to a surface of said auxiliary pattern.

15. A TFT substrate, comprising:
a transparent insulating substrate;
a TFT formed on said transparent insulating substrate; and
a function pattern connected to said TFT,
wherein at least one of said TFT and said function pattern is formed using a printing plate for an offset printing, said printing plate comprising:
a substrate; and
a plurality of concave printing plate patterns formed on said substrate,
wherein at least one auxiliary pattern is located on a bottom of at least one of said concave printing plate patterns and away from a side face of said concave printing plate pattern.

16. The TFT substrate according to claim 15, wherein
said function pattern is any one of a circuit pattern, an electrode pattern and a contact hole pattern.

17. A filter substrate, comprising:
a transparent insulating substrate;
a color filter formed on said transparent insulating substrate; and
a function pattern,
wherein at least one of said color filter and said function pattern is formed using a printing plate for an offset printing, said printing plate comprising:
a substrate; and
a plurality of concave printing plate patterns formed on said substrate,
wherein at least one auxiliary pattern is located on a bottom of at least one of said concave printing plate patterns and away from a side face of said concave printing plate pattern.

18. The filter substrate according to claim 17, wherein
said function pattern is any one of a circuit pattern, an electrode pattern and a contact hole pattern.

19. A liquid crystal display device, comprising:
said TFT substrate according to claim 16.

20. A liquid crystal display device, comprising:
said filter substrate according to claim 17.
